(19) United States
(12) Patent Application Publication
(10) Pub. No.: US 2002/0147845 A1
(43) Pub. Date: Oct. 10, 2002

(54) Flexible user distribution between user's serving entities

(76) Inventors: Juan-Antonio Sanchez-Herrero, Madrid (ES); Isabel Plata-Andres, Madrid (ES)

Correspondence Address: JENKENS & GILCHRIST, P.C., Suite 3200, 1445 Ross Ave., Dallas, TX, 75202, US

(21) Appl. No.: 10/091,658

(22) Filed: Mar. 4, 2002

Related U.S. Application Data
(60) Provisional application No. 60/273,759, filed on Mar. 6, 2001.

(51) Int. Cl. G06F 15/16

(52) U.S. Cl. 709/245; 709/203

(57) ABSTRACT

A User Distribution Server (UDS) is provided in a network having multiple servers and users which are each identified by a plurality of different user identifications. The UDS is located close to an entity disposed to request user information and the UDS responds to a query pertaining to a specific user by redirecting the query to the appropriate server or serving entity. The UDS implements a secondary database with user and server identification information obtained from primary user databases associated with or derived from the servers. The use of distinct primary and secondary databases simplifies data handling, since data changes and updates can be readily managed in the primary databases and then transferred to or actualized in the secondary database.

### CROSS-REFERENCE TO RELATED APPLICATION

This Application for Patent claims the benefit of priority from, and hereby incorporates by reference the entire disclosure of, co-pending U.S. Provisional Application for Patent No. 60/273,759, filed Mar. 6, 2001.

### BACKGROUND OF THE INVENTION

1. Technical Field of the Invention

The invention disclosed and claimed herein generally pertains to large communication networks that use multiple servers to provide services to their users or subscribers, and a given user can be identified or accessed by a number of different user identifiers. More particularly, the invention pertains to a method and apparatus for networks of the above type which enable the appropriate server to be found for providing a specific user with a specific service, without restricting the types of identifications which may be used for both the user and the server providing the service.

2. Description of Related Art

Large telecommunication systems now tend to extend across multiple operator networks, wherein respective networks offer a wide range of different services and are frequently based on different and independent technologies. An important illustration of this development is the interconnection of new emerging Internet based networks, in either a fixed or mobile environment, with traditional wireline and wireless telephony systems. The integration of different operator networks, of different natures and offering different types of services to network subscribers, frequently requires a multiplicity of different servers within a single telecommunications network, to hold subscriptions and to provide services to their users.

On the other hand, the implementation and support of new innovative services by making use of existing network resources, appropriately modified, can become a major impediment to effectively launching these new services into the market, in a timely manner and without risking performance or other features in the existing network resources. A quite commonly used approach has been the introduction of new dedicated servers for introducing services available or intended for use only under certain technologies. One of the basic problems facing the introduction of multiple service-dedicated servers, as well as of multiple subscription-dedicated servers, is thus how to find the appropriate server for serving specific users without any restriction regarding the identification of both the user and the server providing the service. A solution to this problem must be adaptable to user and server identifications which are not presently available or known.

In a further development, a user or subscriber is now likely to be identified in a large telecommunications network by specific user identifiers that are usually different depending on the specific system technologies. In some cases, a particular network supports or uses more than one identifier for the same user. There are networks such as GSM and ANSI-41 that, being conceptually similar in many aspects, make use of different user identifiers. For example, the GSM networks have specific user identifiers such as the IMSI for internal identification purposes, whereas both the GSM and PSTN networks have E.164 identifiers for external identification purposes. Also, the E.164 identifiers can be associated with users or network nodes, and can be used for addressing purposes. In the UMTS network, in like manner with the GSM network, numerical schemes co-exist with non-numerical schemes. As another example, Internet Protocol (IP) multimedia systems make use of different identifiers, typically based on non-numerical schemes such as SIP URL or e-mail names. These identifiers are used to identify subscribers in a particular service environment, that is, subscribers disposed to receive a particular service or set of services. These non-numerical identifiers are also used to identify servers used to perform a particular service, or for addressing purposes such as to address a particular subscriber-related message to a server. On the other hand, the IP multimedia systems also make use of the E.164 identifiers for interconnection with PSTN networks.

The increasing use of different identifications for each user, as well as the presence of multiple servers associated with different services or service environments in a large telecommunication network, requires an improved mechanism for finding the appropriate server for servicing specific users. The improved mechanism must be highly flexible, that is, it must not limit or restrict the use of multiple identifications for either users or servers which provide the services, as described above. The mechanism must also take into account serious real-time constraints in the process of determining which server is the actual or correct one for serving an end-user. Moreover, the provided solution must minimize implementation and configuration complexity and limit operating costs, notwithstanding the large number of users, each with multiple user identifications which may be associated with a communications network.

The above need for more efficient distribution of user identification information was emphasized during the development of IP multimedia subsystems in a telecommunications project known as the 3^{rd} Generation Partnership Project (3GPP). Therein, it was recognized that subscriber specific data such as location or authentication parameters required for the procedure of Registration and Session Establishment, can be held in one particular Home Subscriber Server (HSS) of multiple HSS's included in the network. Accordingly, it is necessary for this procedure to locate the particular HSS holding the data for a particular subscriber. Thus, there is need for providing an efficient functionality for enabling an information requesting node or entity such as an Interrogating Call State Control Function (I-CSCF), to be furnished with the actual name or address of the HSS holding the data for the particular subscriber.

Techniques of the prior art generally have had limitations or shortcomings in solving the problem described above. Some prior art approaches only consider messages transmitted over specific systems such as the SS7 network, or only apply to user identifications based on numbers. Other solutions require that all received messages including the flexible identification, e.g., IMSI or MSISDN, have to be relayed with the consequent traffic load.

### SUMMARY OF THE INVENTION

Embodiments of the present invention solve the problem discussed above by placing a user identification distributor accessible to an entity disposed to request user information. The distributor, or User Distribution Server (UDS) comprises a plurality of user identifiers per subscriber basis that are intended for identifying a user under different service environments. The UDS responds to a query pertaining to a specific user by redirecting the query to the appropriate server or serving entity, in a network having multiple servers. It is to be understood that “redirecting” in this context means answering the query with a server identifier, for the requester node issuing a new query towards the server. The UDS implements a secondary database with user and server identification information obtained from primary user databases, and is arranged for determining a specific network server in charge of a given user under a particular service environment. These specific network servers are considered primary databases wherein subscribers, or more specifically, user data under particular service environment, are distributed. Thus, the UDS acts as a secondary database comprising means for recovering user identifiers and necessary service data from the specific network servers acting as primary databases as well as from other UDS in the network resolution domain. The UDS also comprise storage for user identifiers and necessary service data, if any, per specific network server.

The UDS, being able to determine the specific network server in charge of a given user identified by a certain user identified under a particular service environment, further comprises the means for receiving and processing service requests from a Service Requester Node or from another UDS in the resolution domain. Moreover, the UDS also comprises the means for answering the previous request to the Service Requester Node or to another UDS. In particular, the answer may include the specific network server in charge of the user under a particular service environment, or a list of possible network servers if a redundant configuration exists, or a new user identifier with indication that another query on a given new identifier in another server is necessary, and optionally indicating the reason.

The UDS is adapted for communicating with primary databases, other external databases, and Service Requester Nodes with the same or with different protocols. Therefore, the UDS further comprises at least one of a plurality of Protocol Handler Modules and in some instances a Protocol Discriminator Module.

The invention thus provides a system comprising at least one UDS as described above, though more than one UDS can be included. For instance, different UDS may be in charge of different network domain sectors if proximity criteria, regarding location of the existing Service Requester Nodes, are taken into consideration. In this system, several primary databases may update different UDS with different contents, or with the same contents for redundancy purposes.

In one embodiment, the UDS may act as a Subscription Locator Function. The UDS in this embodiment is able to determine the Home Subscription Server (HSS) in charge of a given subscriber, the HSS acting as primary databases of the UDS The Service Requester Node in this system acts for example as an Interrogating or a Serving Call Status Control Function.

Another embodiment of the invention is directed to a telecommunications system, wherein relevant user identifiers in at least one of a plurality of primary databases may be submitted for updating to one specific UDS, to a group of UDS, or to all UDS known at the at least one primary database. Also, at least one of a plurality of primary databases is arranged for receiving UDS recovery preferences from one specific UDS, from a group of UDS, or from all UDS known at the at least one primary database. The system is further arranged for updating each UDS accordingly with each of the recovery preferences.

Due to the special flexibility provided by a UDS in accordance with the invention, the Service Requester Node may alternatively be a Mobile Switching Center, a Signalling Gateway, a GPRS Supporting Node, or an Application Server for multimedia use. This list is exemplary and is in no way intended to limit the scope of the invention.

### BRIEF DESCRIPTION OF DRAWINGS

FIG. 1 illustrates a generic network architecture showing primary and secondary database structures for an embodiment of the invention.

FIG. 2 shows the contents of an individual record per subscriber in the secondary database of the embodiment of FIG. 1.

FIG. 3A schematically describes an embodiment of the internal architecture of a User Distribution Server for the embodiment of FIG. 1.

FIG. 3B schematically describes another embodiment of the internal architecture of a User Distribution Server, wherein multiple protocols are handled in an external Protocol Adaptation Entity.

FIG. 4 shows an exemplary sequence of flows to be carried out in updating secondary databases with contents from primary databases in the embodiment of FIG. 1.

### DETAILED DESCRIPTION OF PREFERRED EMBODIMENTS

The following describes currently preferred embodiments of means, methods and system for allowing a flexible distribution of users amongst a plurality of servers independently from user identifier schemes, structures and applicable service.

In accordance with an aspect of the present invention, a User Distribution Server (hereinafter UDS) is provided in a network resolution domain for receiving service request related queries for specific users in particular service environments. The UDS is arranged for acting as a secondary database that comprises a plurality of user identifiers on a per subscriber basis, each user identifier applicable in a particular service environment and associated with a server identifier addressing the particular server currently in charge of corresponding user data. These particular servers are arranged for acting as primary databases from which user identifiers and necessary service data are downloaded into the UDS acting as secondary database. The UDS answers a service request related query for a specific user to any service requester node by providing the server identifier to further address the particular server currently serving the user in the applicable service environment.

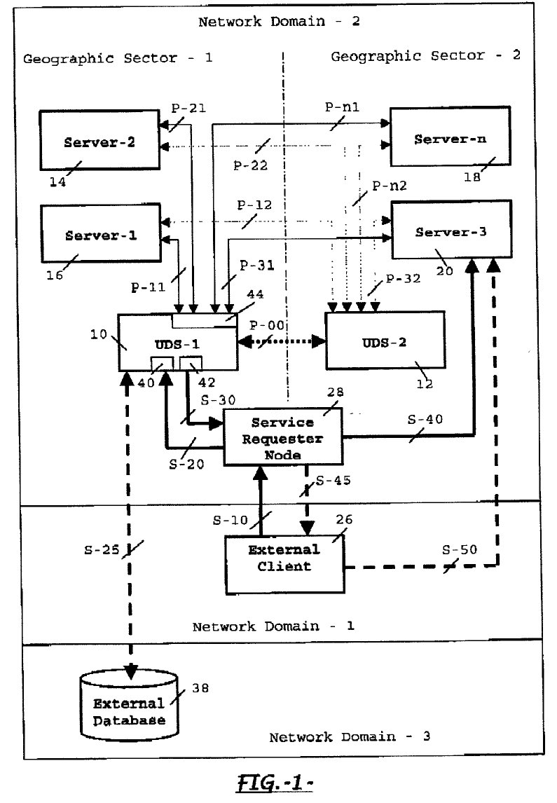

The exemplary architecture in FIG. 1, for allowing a flexible distribution of users, shows how dedicated User Distribution Servers may be in charge of particular geographical locations in a certain network domain. For example, UDS-1 and UDS-2 may be respectively in charge of Geographic Sector-1 and Geographic Sector-2 in a Network Domain-2. UDS-1 and UDS-2 are referenced 10 and 12, respectively. User identifiers may be distributed under different criteria among a plurality of servers in this Network Domain-2, wherein for the sake of clarity just Server-1, Server-2, Server-3, and Server-n are shown. These servers are referenced 14-20, respectively. These Server-1, Server-2, Server-3, and Server-n act as primary databases from which user data are downloaded to UDS-1 and likely to UDS-2 via respective interfaces (P-11, P-12) from said Server-1, (P-21, P-22) from said Server-2, (P-31, P-32) from said Server-3 and (P-n1, P-n2) from said Server-n.

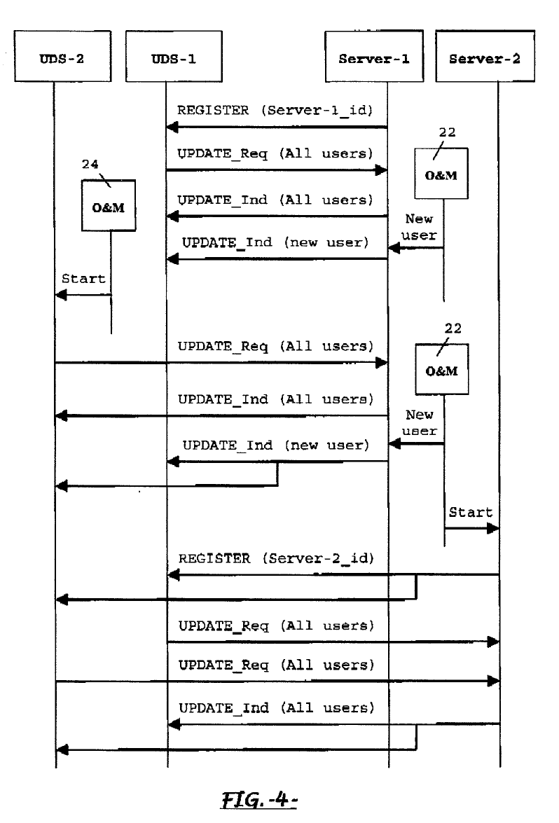

The classification between primary and secondary databases simplifies data handling, allowing changes to be easily managed in primary databases, and those changes to be further updated in secondary databases. An exemplary embodiment of how this updating takes place is presented in FIG. 4, wherein an initial assumption is that UDS-1 already exists in the network and an Operation & Maintenance system 22 has started a new server (Server-1). Under this assumption Server-1 indicates its presence to UDS-1 by means of an applicable protocol operation like REGISTER comprising its own server-1 identifier. The UDS-1 requests update for all relevant users with such server indication in an applicable protocol operation like UPDATE_Req. Upon receiving the request at the Server-1, appropriate user data are submitted with applicable protocol means represented in FIG. 4 by an operation UPDATE_Ind. This operation may in practice represent a certain signalling flow to submit user data for all the subscribers in the Server-1. After having updated the UDS-1, any new update made by O&M system 22 in the primary database like the Server-1, such as a new user, produces an automatic update from the Server-1 towards the UDS-1. Similar protocol means as for all users or others more specifically, both including the new user identifiers, may use, for example the said operation UPDATE_Ind.

The FIG. 4 also shows how another UDS (UDS-2) may be introduced in the network under the assumption that the situation described above has been reached. The UDS-2 is started from O&M system 24, or by other typical means, and is already or recently configured to know the presently existing Servers that it should deal with. Under the assumptions described above, said UDS-2 requests update for all relevant users with similar indication and protocol operation as above, and represented by the operation UPDATE_Req in FIG. 4. Upon receiving the request at the Server-1, a process similar to updating the UDS-1 takes place with necessary update indications (UPDATE_Ind) until downloading identifiers for all users. Provided that any new update is made by the O&M system 22 in the Server-1, like a new user, an automatic update is triggered from said Server-1 towards both UDS-1 and UDS-2.

Another exemplary step in FIG. 4 takes into consideration the introduction of still another server (Server-2) in the scenario above. The Server-2 is started from O&M system 24, or by other typical means, and is already or lately configured to know the presently existing UDS that must be updated. Then, the Server-2 indicates its presence to UDS-1 and UDS-2 by broadcasting the applicable protocol operation, like the aforementioned REGISTER operation, comprising its own server-2 identifier. Then, upon receiving from each UDS the corresponding request for updating all user related information, the Server-2 triggers the corresponding indications (UPDATE_Ind) to the requesting UDS.

As a result of the updating procedures described above, a UDS includes information related to all the servers providing specific services in the network, or in the network sector under its own control, including the relevant served user identifiers on a per subscriber basis. Therefore, primary databases update the UDS where relevant user data change. Moreover, in a resolution domain wherein a plurality of UDS exists, each UDS may maintain redundant information updated either directly from the primary database, or from another UDS, or from both under certain criteria. For example and as depicted in FIG. 1, User Distribution Servers serving different geographic sectors may provide each other the requested information by means of a link (P-00). Preferably, the UDS may contact some specific servers on its own for providing more dynamic information about the serving entity when required.

To this end, servers (Server-1, Server-2, Server-3, Server-n) in a network domain subscribe (P-11, P-21, P-31, P-n1) from themselves to at least one (UDS-1) of a plurality of UDS in the network domain-2. In addition, where another UDS exists (UDS-2) both UDS may communicate (P-00) with each other for cross-checking data, or for reliability reasons, or simply because they are in charge of different geographical areas.

As shown in FIG. 1, a typical flow occurs where an External Client 26 in a network resolution domain, like the Network Domain-1, sends a message (S-10) towards a Service Requester Node, generally speaking, in another network resolution domain like the Network Domain-2. The message could be, for example, part of a call or part of a registration flow, and upon reception the Service Requester node initiates a query (S-20) towards a particular UDS (UDS-1). Said UDS may be assigned at the Service Requester Node for handling the service request related queries by given means such as those carried out during discovery phase, during the start-up phase, or by configuration.

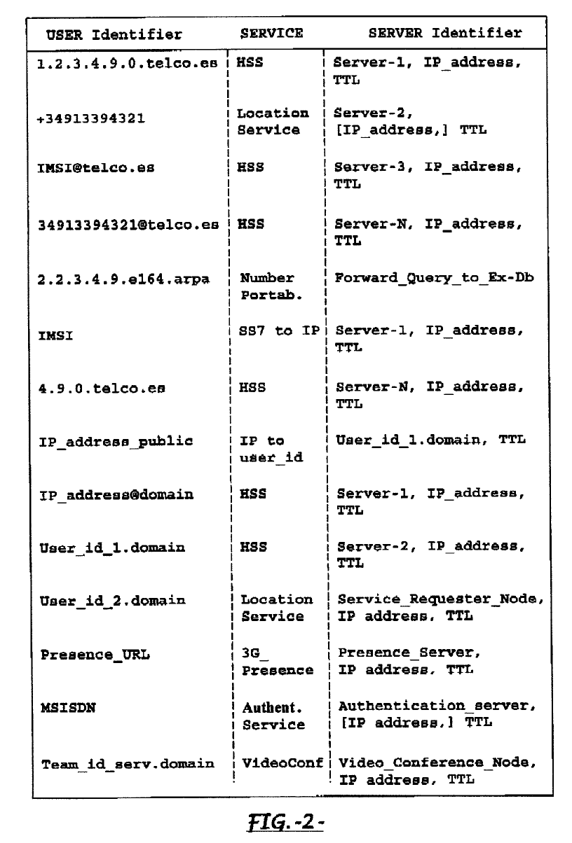

The UDS receiving the query (UDS-1) checks the received parameters, namely the user and/or service related data and, by inspection of its database records, UDS-1 encounters the appropriate server in charge of the specific user under the applicable service environment. In this respect, FIG. 2 presents an explanatory and non-restrictive instance of internal database contents in a UDS according to an aspect of the present invention. FIG. 2 illustrates that a specific user could have different identifiers.

A UDS is queried by the entities requesting the connection with a specific server providing service to the specific user. Therefore, the requesting entity indicates the user identification and optionally other data such as the indication of the requested service. Generally speaking, the UDS database behaviour can be optimised by customised behaviours like, for instance, the fact of accepting queries without explicit indication of the service involved in which case all the stored user data are returned for another node to interpret this result. Given that this user and service related information may change very rapidly, parameters indicating its validity like the Time-To-Live value (hereinafter referred to as TTL) is indicated. Moreover, in the case that more than one server can provide the service to a specific user, for example in case of redundant configurations, the list of possible servers may be indicated. Still further, in case that the user identifier is structured in such way that all users included in a certain level of the structure were served by a specific server, the query's answer may indicate said level of the structure.

However, if the indicated user or service is not available in the network resolution domain the UDS sends the appropriate error. An important aspect in this respect is the ability of UDS for querying an External database (S-25) as shown in FIG. 1 in order to request further information about certain entries, such as for Number Portability resolution. This External database (hereinafter abbreviated as (Ex-Db) might be of a similar structure and have similar contents as the UDS in accordance with an aspect of the present invention, or might have other structure or contents. The interface for consulting this external database might be one of those used between primary and secondary databases or might be a different one.

Once the query has been internally or externally resolved, the UDS-1 returns (S-30) to the Service Requester Node a corresponding response comprising the appropriate server identifier in order to further address the appropriate server. Given that these answers can be cached by the Service Requester Node, a validity time, the aforementioned TTL value, is supplied in the answer to optimise such caching.

Further, the Service Requester Node may either address (S-40) the appropriate server, or correspondingly send (S-45) the expected response to the External Client for the Client to address (S-50), the appropriate server depending on different call premises.

FIG. 1 further shows UDS-1 provided with mechanisms 40 and 42 for respectively receiving a query S-20 and providing a response or answer S-30. UDS-1 is also provided with an operating mechanism 44 for transferring or recovering user identifiers and service data from the server primary databases to UDS-1.

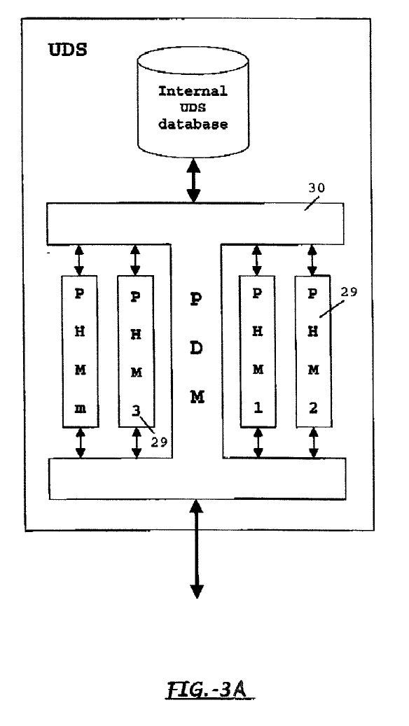

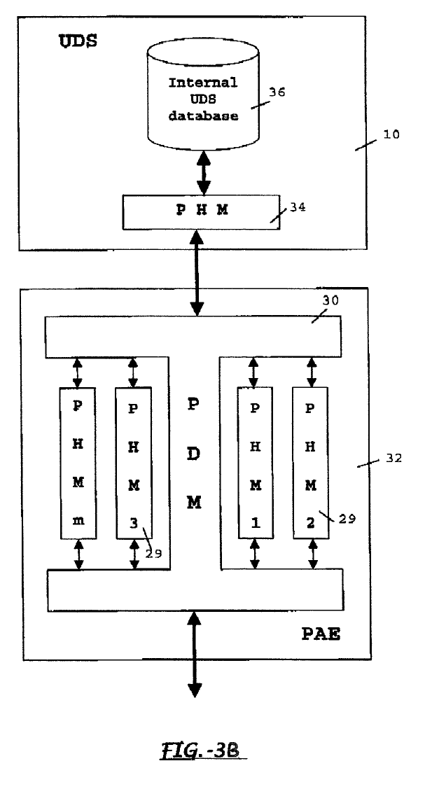

As already mentioned above, the UDS is arranged for handling different protocols for communicating with the different particular servers acting as primary databases, for communicating with eventual External Databases and for communicating with at least one of a plurality of Service Requester Nodes. Thereby, the UDS is equipped with at least one Protocol Handler Module (hereinafter referred to as PHM) enabled for handling at least one of these different communication protocols. Provided that there is more than one of these PHM, a sort of protocol discrimination function is required to determine which particular PHM should deal with a received query, answer, or other message under particular protocol premises. The protocol discrimination function is carried out by an additional Protocol Discriminator Module (hereinafter referred to as PDM) as shown in FIG. 3A and FIG. 3B, and which is only required in case that more than one PHM exists. For instance, the UDS (such as UDS-1 or UDS-2) may be able to interpret queries and submit responses with support of telecommunication protocols preferably operating in accordance with at least one of “Domain Name Server” (DNS) protocol, “Light-Weight Directory Access Protocol” (LDAP), Radius protocol, or Diameter protocol. These protocols are referred to in a non-restrictive manner, to merely outline the clear advantage of having a UDS arranged for supporting several protocols that might be changed by replacing or adding individual Protocol Handler Modules accompanied by amendments carried out only in the Protocol Discriminator Module.

The FIG. 3A shows a preferred embodiment of UDS 10 comprising several PHM 29 (further referenced as 1-3, m) and a unique PDM 30. A person of skill in the art will appreciate that similar embodiments may be achieved by separating a number of PHM 29 and PDM 30 integrated in a so-called Protocol Adaptation Entity (hereinafter PAE) 32. As shown in FIG. 3B, a dedicated PHM could be reserved at the PAE for internal communication with the UDS 10 wherein there is also a unique dedicated PHM 34. FIG. 3B also shows the UDS having an internal database 36.

Additional advantages may be obtained if secondary databases, namely the UDS, are geographically nearer to the requester of information, the so-called Service Requester Node 28, in order to speed up the resolution process, though said advantage is not an essential feature.

Irrespective of geographical location, first queries are requested from secondary databases like the UDS whereas primary databases are further queried only where a first query was successfully answered. This procedure can be useful to avoid the overload of primary databases due to queries for non-existing users, generally known as “Denial of Service” (DOS) attacks. This solution needs no special security protection different from any other standard node in the operator network, having its deployment internal to the network operator or in a trust-relationship environment like that of partners operating in different countries reusing certain infrastructure.

The architecture shown in FIG. 1 as well as the essential features and advantages described above for the UDS are suitable for use in telecommunication systems operating in accordance with the 3^{rd} Generation Partnership Project (3GPP). More specifically, the UDS is operable as a Service Locator Function (SLF) as described in the Annex F of the Technical Specification (TS) 23.228 of said 3GPP.

As described in said TS, the Home Subscriber Server (HSS) currently holding subscriber specific data, like user location or authentication parameters for example, must be identified during the Registration and the Session or Call Establishment, as most probably there are more than one HSS in the operator's network. The identification of a particular HSS is required for an Interrogating Call Status Control Function (I-CSCF) node and for a Serving Call Status Control Function (S-CSCF) node, in order to get the actual name and/or address of the HSS in charge of a given subscriber. More specifically, the I-CSCF node needs the HSS identification during both the Registration and the Session or Call Establishment, whereas the S-CSCF node needs such HSS identification only during the Registration. This description simply refers to a Call Status Control Function (CSCF) node, for the sake of simplicity, where the explanation may well apply to the Interrogating or to the Serving CSCF.

In this scenario, the different HSS wherein subscribers are distributed are arranged for acting as primary databases as the ones previously shown in FIG. 1 and referred to in this application as Server-i (being i from 1 to n), whereas the CSCF node is arranged for acting as the aforementioned Service Requester Node 28. In accordance with the invention, the aforementioned UDS 10 is then operable as the Service Locator Function (SLF) acting as a secondary database for receiving queries from the CSCF, encountering the HSS in charge of a given subscriber, and answering the result to said CSCF.

Therefore, a UDS arranged for acting as an SLF comprises at least one Protocol Handler module for handling the received and answered queries from and to the CSCF node. Moreover, provided that the protocol suitable for communication between SLF and HSS is other than the one between SLF and CSCF, the UDS arranged for acting as an SLF comprises another Protocol Handler Module (PHM) for handling updates or downloads with the HSS. As already mentioned, a Protocol Discriminator Module (PDM) is included in a UDS where more than one PHM is used.

For instance, the interface between a CSCF and a UDS, the latter arranged for acting as an SLF, includes an operation for querying the Subscription Locator from the CSCF, and a response for providing the HSS address towards the CSCF. Specifically, by sending an operation like SLF_QUERY the CSCF indicates the subscriber identity (received during the Registration or the Session or Call Establishment) for which an HSS is looked for. Then, by returning the operation SLF_RESP the UDS acting as an SLF responds with the HSS name and/or address for the CSCF to continue by querying the given HSS. Alternatively, the operation SLF_RESP may indicate a new user identifier with an indication that another query must be done. This indication may either comprise the address for the new query with an indication of the reason, or merely be a reason for a new query. The former indication type is used for Number Portability, for instance, whereas the latter implies that the address of the new server must be found out by the querying entity. Provided that the exemplary DNS protocol above, between a CSCF and an SLF, is also used between the SLF and the HSS, the operation SLF_UPDATE_REQUEST may be used for requesting user data from each particular HSS. Then, the operation SLF_UPDATE is used for updating the UDS, acting as an SLF, from an HSS at any time a change occurs in such HSS.

Optionally during the registration flow, the Interrogating CSCF (I-CSCF) may forward the HSS address towards a Serving CSCF (S-CSCF) to simplify the S-CSCF behaviour to find the HSS. If the received user identifier does not correspond to any known user the corresponding error is returned.

Under the exemplary use of a DNS protocol, though also applicable under other protocols like DIAMETER or RADIUS for example, the updating of a secondary database like a UDS acting as an SLF from primary databases like the HSS comprises dedicated means anticipated in FIG. 4.

The SLF_UPDATE_REQUEST operation, namely UPDATE_Req in FIG. 4, provides the means for the querying entities to indicate specific operations requested on all or a set of identifiers space. Said operation comprises means for requesting “all user data” or “specific used data” for one or a set of users. An example of this is only Circuit Switching (hereinafter CS) access related data, or only Packet Switching (hereinafter PS) access related data, or only Internet protocol Multimedia (hereinafter IM) related data. Said operation further comprises means for requesting a “set of specific data” Service Network (hereinafter SN), related to what in fact may include a set of services, for one or a set of users. Moreover, said operation also comprises means for requesting only a specific type of identifiers, for example and in a non-restrictive manner, E.164 numbers or SIP_urls. Still further, said operation comprises means for requesting only identifiers belonging to a specific identification space like, for instance, only identifiers into the acme.land domain.

Correspondingly, the SLF_UPDATE response operation, namely UPDATE_Ind in FIG. 4, provides the means for indicating to the querying entities that “all user data” or only “specific user data” are updated for a specific user or for a set of users.

On the other hand, the range of entities to be requested for updating as well as the range of entities being effectively updated in respect of a unique service, a set of services, or all the services for one, a group of, or all subscribers, as described above with reference to FIG. 4, also has applicability in this case.

In summary, the SLF_UPDATE_REQUEST operation, namely the UPDATE_Req in FIG. 4, provides means to indicate:

Range of users, in terms of one user, a set of users under some grouping condition, or all users.

Range of services, in terms of a specific service, a set of services, or all services.

Range of entities to be queried, in terms of one entity, a set of entities under some conditions, that is Multicast, or all entities, namely Broadcast.

Correspondingly, the SLF_UPDATE response operation, the UPDATE_Ind in FIG. 4, provides means to indicate:

Range of users, in terms of one user, a set of users under some grouping condition, or all users.

Range of services, in terms of a specific service, a set of services, or all services.

Range of entities to be updated, in terms of one entity, a set of entities under some conditions, that is Multicast, or all entities, namely Broadcast.

When a new UDS acting as an SLF is introduced in the network, as anticipated above with reference to FIG. 4, a query is launched to all nodes providing service, that is, to all the primary databases, namely broadcast to primary databases like HSS. On the other hand, the removal of a querying entity like the UDS from the network may be preceeded by an alert message OUT_OF_SERVICE_like towards all cooperating primary databases or, alternatively, additional presence-related mechanisms ACTIVITY_TEST_like are provided at the primary databases to be periodically invoked. A similar approach is used in accordance with the invention where any primary database like HSS is removed from the network, either the aforementioned mechanism OUT_OF_SERVICE_like, or the respective ACTIVITY_TEST_like related mechanism. Regarding the introduction, removal or modification of user data, the aforementioned UPDATE_Ind includes appropriate indicator values to unambiguously interpret the type of updating.

Even though the request for updating as well as the updating itself are intentionally and preferably carried out on primary and secondary database premises, it might occur as well that the secondary database UDS does not know some specific user data recently requested. In this situation, and inasmuch as the UDS knows how to locate another primary or secondary database holding such data, a new query is issued from the receiver UDS towards another UDS or towards another external database. This is especially useful for Number Portability support for which an additional explanatory use case is further provided in this description.

An aspect of particular interest is the optimal behaviour of an UDS according to the invention acting as an SLF and thus inter-working with the CSCF during the Registration phase. The explanations following this are aimed with reference to interfaces and entities in FIG. 1. First, the CSCF (Service Requester Node) receives a REGISTER request (S-10) and must initiate a query for the location of the subscriber's data. Second, the CSCF sends an operation SLF_QUERY_like (S-20) to the SLF (UDS-1) and includes the subscriber identity as stated in the REGISTER request. The protocol to use is not significant at this point since the UDS according to the invention may be equipped with a plurality of Protocol Handler Modules (PHM), as shown in FIG. 3A, in a manner such as being appropriate for communicating with DNS, DIAMETER, RADIUS or any other suitable protocol. Moreover, the aforementioned Protocol Adaptation Entity 32 in FIG. 3B may be interposed between the CSCF and the UDS to this end. Third, and still with reference to FIG. 1, the SLF (UDS-1) looks up its own database contents as shown in FIG. 2 by way of example for the queried subscriber identity. Fourth, and again with reference to FIG. 1, the SLF (UDS-1) answers (S-30) with the HSS name in which the subscriber's data can be found. Fifth, the CSCF preferably launches a query directly to the HSS (Server-3) (S-40). Alternatively to the fifth step above and under certain call premises, the CSCF (Service Requester Node 28) may proceed by returning the query result (S-45) to the External Client 26 having issued the Registration request, for said External Client querying (S-50) the appropriate HSS (Server-3).

Apart from what has been stated above for the case of receiving a Registration request at a CSCF entity, a similar approach and behavior is expected from a UDS according to the invention for the case of an I-CSCF node participating in a Session or Call Establishment.

A further advantage of using a UDS according to the invention as an SLF is how easily specific queries can be performed to External Databases 38 and thus supporting number portability queries in both scenarios: at a donor network, and at an originating network.

At a donor network the UDS concept can be used to handle number and name portability under some conditions. It might well happen that, as it is currently regulated in some scenarios, some flows get to an I-CSCF of a network not currently holding the user's subscription. When such an I-CSCF queries the SLF, a discrimination must be applied in this step to avoid those queries from a ported user that can get into an HSS of this network. With reference to FIG. 1, the I-CSCF (Service Requester Node) receives an INVITE request (S-10) and must query for the location of the subscriber's data. The I-CSCF sends a SLF_QUERY (S-20) to the SLF (UDS-1) and includes as a parameter the subscriber identity previously received in the INVITE request. The SLF (UDS-1) looks up its own local database for the queried subscriber identity. An exemplary entry for identifier “2.2.3.4.9.e164.arpa” in FIG. 2 discloses that this user is ported with an indication of type “Forward_query_to_Ex_Db” as server identifier. Then, the SLF (UDS-1) queries the Portability DataBase (External Database 38), as represented in FIG. 1 with interface S-25, and obtains from the Portability DataBase the identifier to be used for contacting the user. Next, the SLF (UDS-1) answers (S-30) to the I-CSCF (Service Requester Node) with an address or URL for reaching the said subscriber. The I-CSCF may now order to redirect the INVITE message to the network where the user has been ported.

On the other hand, the UDS can be also advantageous for solving number portability in originating networks where the query is actually performed from a Serving Call Status Control Function (S-CSCF) entity. In this respect, the same principles apply for querying from an S-CSCF to an UDS, which is acting as an SLF, as for querying from the above indicated I-CSCF.

Many other scenarios can make advantageous use of the UDS in accordance with the invention. For instance, said UDS may offer substantial support for a Virtual Network Operator owning its own HSS, said own HSS being identified through a UDS acting as an SLF in a non-virtual network addressed as corresponding network resolution domain.

Another instance of the applicability of an UDS according to the invention is the Registration of users in external Internet protocol Multimedia Service Providers (hereinafter IMSP). The UDS concept can be used following the same principles as above but, in this case, the contact name indicated by the user may be applied for identifying the domain where the IMSP provides the service. In other words, the Home operator acts as a sort of broker, namely a Service provider that provides contact addresses for the user, based on any preferences of this user, or provides a redirection service as for the case of Number or Name Portability.

Still another advantageous use is consideration of queries and responses throughout the so-called Sh interface between an HSS and an Application Server (hereinafter AS) in an IP Mobility Management (IPMM) architecture. Said Application servers must have access to user data stored in the HSS, but it is not feasible that they know the addresses of all the HSS for all users, as the case was for I-CSCF or S-CSCF. Therefore, the same UDS according to the present invention seems to be applicable also for this case where an entity like said UDS may be placed between HSS and AS for the purpose of redirecting the queries from AS towards the correct HSS on per user and/or service requested.

Advantages and different scenarios for use have been identified above, most of them related to the newer generations of wireless systems and especially regarding their connectivity with newer Multimedia and Internet related services. However, there is still another advantageous application of the UDS to classical GSM or UMTS identifiers. The UDS concept can be used using the same principles but, in this case, the contact name indicated by the user may be the IMSI or the MSISDN depending on the specific message flow. This can be done based on mapping these numbers to routable names as already proposed in ENUM protocol, which maps E.164 numbers to routable names. In this particular case and with reference to FIG. 1, the querying entities represented by the Service Requester Nodes are the Mobile Switching Center server (MSC), the Gateway MSC server (GMSC), the Serving GSM Server Node (SGSN), or the Gateway GSM Server Node (GGSN). These entities are cited for example and in a non-restrictive manner. Moreover, in this classical GSM or UMTS environment HLR and HSS are the primary databases represented by Server-1 to Server-n. The Service Requester Node could also be a Signalling Gateway; a GPRS Supporting Node; an Open Service Architecture Service Capability Server; a Multimedia Messaging Server; or a CAMEL Gateway Server.

Although preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the scope of the invention as set forth and defined by the following claims.

What is claimed is:

1. In a network resolution domain having a plurality of user identifiers on a per subscriber basis for identifying a user under different service environments, a User Distribution Server (UDS) disposed to determine from a plurality of network servers the specific network server in charge of said user under a particular service environment, said UDS comprising:
a secondary database providing storage for user identifiers and selected service data pertaining to said network servers;
a mechanism for transferring user identifiers and said selected service data to said secondary database from primary databases associated with respective network servers;
a querying mechanism disposed to receive a service request from a Service Requester Node; and
a response mechanism disposed to transmit an answer message to said Service Requester Node in response to said request, said answer comprising information usable by said Service Requester Node to determine said specific network server.

2. The User Distribution Server (UDS) of claim 1 wherein:
said response mechanism transmits an answer comprising, selectively, the specific network server in charge of said user under a particular service environment; a list of possible servers if a redundant configuration exists; and a new user identifier with an indication that another query on said new identifier is necessary.

3. The User Distribution Server (UDS) of claim 1 wherein:
said UDS is adapted as a first UDS and said network includes a second UDS, and wherein:
said transfer, querying and response mechanism are respectively disposed to transmit data between said first UDS and said second UDS.

4. The User Distribution Server (UDS) of claim 1 wherein:
said transferring mechanism comprises operating means for recovering user identifiers and necessary service data from specific network servers acting as primary databases.

5. The User Distribution Server (UDS) of claim 1 wherein:
the operating means includes means for informing said UDS about needs for updating user identifiers and/or necessary service data at indication from primary databases or another UDS.

6. The User Distribution Server (UDS) of claim 5, wherein:
the operating means includes means for said UDS registering into and withdrawing from all network servers intended for acting as primary databases.

7. The User Distribution Server (UDS) of claim 6 wherein:
the operating means includes means for indicating recovery preferences for recovering user identifiers and/or necessary service data for all served users, for a specific set of users, or only for a particular user

8. The User Distribution Server (UDS) of claim 7 wherein:
the operating means further includes means for recovering user identifiers and necessary service data selectively, for at least one set of:
(a) identifiers of a specific type amongst a plurality of valid identifier types;
(b) identifiers used in specific domains; and
(c) identifiers belonging to specific identification spaces in a domain.

9. The User Distribution Server (UDS) of claim 8 wherein data sensitive to temporary validity per specific network service include a “Time To Live” (TTL) parameter intended for determining the needs for data recovery from primary databases.

10. The User Distribution Server (UDS) of claim 8, further comprising:
at least one protocol handler module and, in the event said UDS comprises more than one protocol handler module, a protocol discriminator module, each protocol handler module being in charge of a particular telecommunications protocol.

11. The User Distribution Server (UDS) of claim 10, comprising:
at least one “Domain Name Server (DNS)” related protocol handler module.

12. The User Distribution Server (UDS) of claim 10, comprising:
at least one “Diameter” related protocol handler module.

13. The User Distribution Server (UDS) of claim 10, comprising:
at least one “Light-Weight Directory Access Protocol (LDAP)” related protocol handler module.

14. The User Distribution Server (UDS) of claim 10 comprising:
at least one “Radius” related protocol handler module.

15. The User Distribution Server (UDS) of claim 10, further comprising protocol and processing means for responding to the service request using an external database not intended for acting as primary database or as another UDS.

16. The User Distribution Server (UDS) of claim 15, wherein said external database is a number portability database.

17. A telecommunications system comprising:
at least one subscriber having a plurality of user identifiers for identifying said subscriber under different service environments;
a plurality of servers; and
a User Distribution Server (UDS) for determining a specific network server in charge of said user under a particular service environment, wherein said UDS comprises:
a secondary database providing storage for user identifiers and selected service data pertaining to said servers;
a mechanism for transferring user identifiers and said selected service data to said secondary database from selected servers acting as primary databases;
a querying mechanism disposed to receive a service request from a Service Requester Node; and
a response mechanism disposed to transmit an answer in response to said request for use by said Service Requester Node in determining said specific network server.

18. The telecommunications system of claim 17 wherein:
relevant user identifiers in at least one of a plurality of primary databases may be submitted for updating to one specific UDS, to a group of UDS, or to all UDS known at said at least one primary database, selectively.

19. The telecommunications system of claim 18, wherein:
at least one of a plurality of primary databases is arranged for receiving UDS recovery preferences from one specific UDS, from a group of UDS, or from all UDS known at said at least one primary database, selectively, and for updating each UDS accordingly with each of the recovery preferences.

20. The telecommunications system of claim 19, wherein:
the UDS acts as a Subscription Locator Function (SLF).

21. The telecommunications system of claim 19, wherein:
at least one of a plurality of specific servers acting as primary databases is a Home Subscription Server (HSS).

22. The telecommunications system of claim 19, wherein:
at least one of a plurality of specific servers acting as primary databases is a Presence Server.

23. The telecommunications system of claim 17, wherein:
at least one of a plurality of Service Requester Nodes is an Interrogating Call Status Control Function (I-CSCF).

24. The telecommunications system of claim 17, wherein:
at least one of a plurality of Service Requester Nodes is a Serving Call Status Control Function (S-CSCF).

25. The telecommunications system of claim 17, wherein:
at least one of a plurality of Service Requester Nodes is a Mobile Switching Center (MSC).

26. The telecommunications system of claim 17, wherein:
at least one of a plurality of Service Requester Nodes is a Signalling Gateway.

27. The telecommunications system of claim 17, wherein:
at least one of a plurality of Service Requester Nodes is a GPRS Supporting Node.

28. The telecommunications system of claim 17, wherein:
at least one of a plurality of Service Requester Nodes is an Application Server (AS) intended for multimedia related use.

29. The telecommunications system of claim 17, wherein:
at least one of a plurality of Service Requester Nodes is an Open Service Architecture Service Capability Server.

30. The telecommunications system of claim 17, wherein:
at least one of a plurality of Service Requester Nodes is a Multimedia Messaging Server.

31. The telecommunications system of claim 17, wherein:
at least one of a plurality of Service Requester Nodes is a CAMEL Gateway Server.

32. The telecommunications system of claim 17, wherein:
at least one of a plurality of external databases used for resolution is a Domain Name Server.

33. The telecommunications system of claim 17, wherein:
at least one of a plurality of external databases used for resolution is a database system based on Light-Weight Directory Access Protocol (LDAP).

34. The telecommunications system of claim 17, wherein:
at least one of a plurality of external databases used for resolution is a number portability database.

35. In a network resolution domain having a plurality of user identifiers on a per subscriber basis for identifying a user under different service environments, and wherein a User Distribution Server (UDS) is disposed to determine from a plurality of network servers the specific network server in charge of said user under a particular service environment, a method for operating the UDS comprising the steps of:
establishing a secondary database in said UDS for storing user identifiers and selected service data pertaining to said network servers;
transferring user identifiers and said selected service data to said secondary database from primary databases associated with respective network servers;
receiving a service request from a Service Requester Node; and
transmitting an answer message from said UDS to said Service Requester Node in response to said request, said answer comprising information usable by said Service Requester Node to determine and specific network server.

36. The method of claim 35 wherein:
said transmitted answer comprises, selectively, the specific network server in charge of said user under a particular service environment; a list of possible servers if a redundant configuration exists; and a new user identifier with an indication that another query on said new identifier is necessary.

37. The method of claim 35 wherein said UDS comprises a first UDS and said network includes a second UDS, and wherein:
said transfer, receiving and answer transmitting steps, respectively include data transmission between said first UDS and said second UDS.
